(19) United States
(12) Patent Application Publication
(10) Pub. No.: US 2010/0212160 A1
(43) Pub. Date: Aug. 26, 2010

(54) EXTERNAL CUTTER STRUCTURE OF RECIPROCATING ELECTRIC SHAVER AND METHOD OF MAKING THE SAME

(75) Inventor: Lai-Sheng LIU, Xiamen (CN)

Correspondence Address: Dr. BANGER SHIA;Patent Office of Bang Shia, 102 Lindencrest Ct, Sugar Land, TX, 77479-5201, US

(73) Assignee: XIAMEN SHINHWA PATENT & TRADEMARK AGENCY CO., LTD., Fujian (CN)

(21) Appl. No.: 12/678,483

(22) PCT Filed: Sep. 17, 2007
(86) PCT No.: PCT/CN2007/002739

§ 371 Date: Mar. 17, 2010

(51) Int. Cl. B26B 19/04; B23P 25/00; B26B 19/38

(52) U.S. Cl. 30/43.92; 29/527.2

(57) ABSTRACT

A external cutter structure of reciprocating electric shaver and the method of making same, the cutter is made of a thin plate and is formed a strip shape by bending, it is provided on the head of the shaver, and it has a top surface and two side surfaces, the top surface includes strength parts at the both ends and a cutting blade part at the middle, the thickness of middle is reduced, a plurality of blades in the form of long grooves are formed on the blade part of the top surface. Said external cutter structure is simple, its strength is high and its distortion isn't easy, it can shave long beards, crimped bears and short beards at the same time.

### BACKGROUND OF THE INVENTION

1. Field of the Invention

The present invention generally relates to a technical area of reciprocating electric shavers, and more particularly to an improved external cutter structure of a reciprocating electric shaver and its manufacturing method.

2. Description of the Related Art

In general, a traditional shaver has an external cutter substantially in the shape of a thin plate, a plurality of small holes in a circular shape or another shape, and a blade installed under the external cutter, wherein a top side of the internal blade is in an arc shape, and the external cutter forms an arc shape along the circular curve of the internal blade, and the internal blade is driven by a transmission device of an internal electric motor for shaving beards. When the shaver is attached onto a user's face, the user's beards are extended into the shaver through the small holes of the external cutter and cut by the internal blade quickly to achieve the shaving effect. Since the small holes have a small diameter, it is easy for short beards to be extended into the shaver, but difficult for curly beards or long beards to pass the small holes. During use, long beards are usually cut first and then shaved, or the long beards are cut first and then trimmed Obviously, such conventional shaver has the drawback and inconvenience of shaving long beards completely at a time, or achieving the effect of shaving both long and short beards completely at a time.

Therefore, manufacturers developed a shaver having three symmetric circular external cutters, and long slots are formed on each external cutter. Since the long beards can enter into the long slots easily, therefore such shaver can achieve the effect of shaving both long beards and short beards at a time. However, three external cutters are installed in three different positions of the shaver, and thus the external cutters cannot be in contact with the user's face closely, and the shaving area becomes smaller. Users have to turn the shaver at different angles in order to increase the shaving area, and such operation is definitely inconvenient.

Some manufacturers also developed a shaver whose external cutter is formed by bending a thin plate into a strip shape, and long slots are also formed on the external cutter and transversally installed at a shaver head. This shaver can shave the long beards or curly beards completely at a time, and the external cutters installed transversally can increase the contact surface with the user's face, so that users simply tilt the shaver without the need of turning the shaver to increase the shaving area and provide a convenient operation. However, the external cutter blade of this shaver has a relatively large thickness ranging from 0.15 mm to 0.3 mm, and thus the short beards cannot be shaved completely, and such shaver cannot be used by itself , and it must work together with a blade of a thin arc external cutter (for shaving short beards) to shave all beards completely.

In summation, the external cutter structure of the conventional shavers still has its deficiency and requires further improvements.

### SUMMARY OF THE INVENTION

In view of the shortcomings of the prior art, the inventor of the present invention based on years of experience in the related industry to conduct extensive researches and experiments, and finally invented an external cutter structure of a reciprocating electric shaver and its method.

Therefore, it is a primary objective of the present invention to overcome the aforementioned shortcoming and deficiency of the prior art by providing an external cutter structure of a reciprocating electric shaver and its manufacturing method, wherein the external cutter structure is a simple structure with a high strength for preventing deformations and providing the effect of shaving all long beards or curly beards and short beards completely at a time.

To achieve the foregoing objective, the present invention provides an external cutter structure of a reciprocating electric shaver, and the external cutter is formed by bending a thin plate into a strip shape and the thin plate is transversally installed at a shaver head, and the external cutter structure has a top side and lateral sides, and the top side includes a reinforcing portion disposed separately at both ends of the top side, a blade portion having a reduced thickness at the middle of the blade portion, and a plurality of long slots formed on the blade portion of the top side to manufacture a blade.

The external surface at the middle of the top side has a reduced thickness, and the reinforcing portions formed at both ends of the external surface of the top side are higher than the blade portion to form a step shape, and the reinforcing portions at both ends of the external surface of the top side are aligned evenly with the blade portion.

The internal surface at the middle of the top side has a reduced thickness, and the reinforcing portions formed separately at both ends of the external surface of the top side are aligned evenly with the blade portion, and the reinforcing portions formed at both ends of the external surface of the top side are lower than the blade portion to form a step shape.

The internal surface and external surface at the middle of the top side have a reduced thickness, and the reinforcing portions formed at both ends of the external surface of the top side are higher than the blade portion to form a step shape, or the reinforcing portions formed at both ends of the external surface of the top side are lower than the blade portion to form a step shape.

The long slots formed on the blade portion are extended from the top side to a position of the lateral side proximate to the top side.

The top side of the blade portion has a planar or protruding curved surface. The reinforcing portions formed separately at both ends of the top side have a thickness of 0.1-0.6 mm

The blade portion of the top side has a thickness of 0.04-0.09 mm There are two or more rows of blades formed by long slots and installed at the external cutter of the shaver, and each row of blades is independently formed. In other words, each blade is formed by bending a thin plate into a strip shape, and each independent strip shape includes a top side and lateral side, and the top side of each independent strip shape includes a reinforcing portion formed separately at both ends of the top side and a blade portion having a reduced thickness in the middle, and the blade portion on the top side of each independent strip shape includes a row of blades formed by the long slots, and the rows of blades are parallel to each other and transversally installed at a shaver head.

There are two or more rows of blades formed by the long slots and installed at the external cutter of the shaver, and the two or more rows of blades are integrally formed by bending a same piece of thin plate into a strip shape, and the strip shape has a top side and lateral sides, and the top side includes a reinforcing portion formed separately at both ends of the top side, a blade portion having a reduced thickness at the middle, and two or more rows of parallel blades formed by long slots on the blade portion at the top side of the strip shape, and a reinforcing rib is stamped and formed between two adjacent rows of blades.

The external cutter of the shaver includes long-slot blades and small-hole blades arranged alternately, and the two types of blades are formed separately. In other words, the two types of blades are formed by bending different thin plates into an independent strip shape, and each independent strip shape has a top side and lateral sides, and the top side of each independent strip shape includes a reinforcing portion formed separately at both ends of the top side and a blade portion having a reduced thickness at the middle. Long slots and small holes are formed on the blade portion on the top side of each independent strip to form a row of blades, wherein the rows of blades are parallel to each other and transversally installed at a shaver head.

The external cutter of the shaver includes long-slot blades and small-hole blades arranged alternately, and the two types of blades integrally formed by bending the same piece of thin plate into a strip shape, and the strip shape includes a top side and lateral sides, and the top side includes a reinforcing portion separately formed at both ends of the top side and a blade portion having a reduced thickness at the middle. Long slots and small holes are formed on the blade portion at the top side of the strip shape to form a row of blades, wherein the long-slot blades and the small-hole blades are parallel to each other, and a reinforcing rib is stamped and formed between two adjacent rows of blades.

A first manufacturing method of an external cutter of a reciprocating electric shaver comprises the steps of: bending a thin plate into a strip shape to manufacture a top side and lateral sides; performing a quenching process; reducing the thickness at the middle of the top side of the external cutter in the strip shape; manufacturing a reinforcing portion at both ends of the top side separately; producing long slots in the middle area with the reduced thickness to form a blade portion; and polishing an external surface and refining an internal surface.

The thickness at the middle of the top side of the external cutter can be reduced by any one or a combination of grinding, laser, milling, electric corrosion and electrochemical corrosion methods.

The long slots can be formed in the area having the reduced thickness at the middle of the top side of the external cutter by any one or a combination of laser, electric corrosion, electrochemical corrosion, and milling methods.

The small holes can be formed in the area having the reduced thickness at the middle of the external cutter by any one or a combination of the laser, electric corrosion, and electrochemical corrosion methods.

A second manufacturing method of an external cutter reciprocating of an electric shaver comprises the steps of: stamping and bending a thin plate into a strip shape; manufacturing a top side and lateral sides; forming a reinforcing portion separately from both ends of the top side by a stamping process, wherein the middle of the top side is sunken; reducing the thickness of the sunken position at the middle of the top side by a manufacturing process; manufacturing a blade portion formed by long slots in the area of the reduced thickness at the middle, performing a quenching process, and polishing an external surface and refining an internal surface.

The thickness at the middle of the top side of the external cutter is reduced by any one or a combination of the laser, milling, electric corrosion and electrochemical corrosion methods.

The long slots are formed at the middle of the top side of the external cutter with a reduced thickness by any one or a combination of the laser, electric corrosion, electrochemical corrosion and milling methods.

The small holes are formed in the area with a reduced thickness at the middle of the top side of the external cutter by any one or a combination of mold stamping, laser, electric corrosion and electrochemical corrosion methods.

A third manufacturing method of an external cutter reciprocating of an electric shaver comprises the steps of: bending a thin plate into a strip shape; manufacturing a top side and lateral sides; reducing the thickness at the middle of the top side of the strip shaped external cutter; manufacturing a reinforcing portion separately at both ends of the top side; forming long slots in an area with the reduced thickness at the middle to produce a blade portion; performing a quenching process; and polishing an external surface and refining an internal surface.

The thickness at the middle of the top side of the external cutter is reduced by any one or a combination of the laser, milling, electric corrosion and electrochemical corrosion methods.

The long slots are formed at an area with the reduced thickness at the middle of the top side of the external cutter by any one or a combination of the laser, electric corrosion, electrochemical corrosion and milling methods.

The long slots are formed in an area with the reduced thickness at the middle of the top side of the external cutter by any one or a combination of the grinding, laser, electric corrosion, electrochemical corrosion and milling methods.

The small holes can be formed in the area having the reduced thickness at the middle of the external cutter by any one or a combination of the laser, electric corrosion, electrochemical corrosion, and mold stamping methods.

A fourth manufacturing method of an external cutter reciprocating of an electric shaver comprises the steps of: stamping and bending a thin plate into a strip shape; forming a top side and lateral sides; forming a reinforcing portion separately from both ends of the top side by a stamping process, wherein the middle of the top side is sunken; performing a quenching process; reducing the thickness of the sunken position at the middle of the top side by a manufacturing process; manufacturing a blade portion formed by long slots in the area of the reduced thickness at the middle; and polishing an external surface and refining an internal surface

The thickness at the middle of the top side of the external cutter is reduced by any one or a combination of the laser, milling, electric corrosion and electrochemical corrosion methods.

The long slots are formed in an area with the reduced thickness at the middle of the top side of the external cutter by any one or a combination of the laser, electric corrosion, electrochemical corrosion and milling methods.

The small holes can be formed in the area having the reduced thickness at the middle of the external cutter by any one or a combination of the laser, electric corrosion, and electrochemical corrosion methods.

With the aforementioned solutions provided by the present invention, the thin plate is bent, and the thickness of the top side is reduced, and the plurality of long slots are formed to manufacture the blade, such that the blade has an appropriate thickness, and the manufactured shaver makes use of its long slots to allow curly long beards to enter into the shaver in order to shave all long beards or curly beards at a time. Since the blade is thin enough, all short beards can be shaved completely at the same time, therefore the present invention can achieve the effect of shaving both long beards or curly beards and short beards completely at the same time. In addition, the transversally installed external cutters increase the contact surface with the user's face to make the shaving more convenient. More importantly, the reinforcing portions formed at both ends of the external cutter are thick and the middle blade is thin in accordance with the present invention, so that the overall strength of the shaver can be enhanced, and the shaver will not be deformed easily after a long time of use. The invention also allows a user to attach the external cutters closer to the user's face and assures the effect of shaving all beards quickly at a time.

The present invention has the advantages of a simple structure, an easy manufacture, and an enhanced strength of the external cutters, so as to facilitate the process of assembling the external cutters onto the shaver and provide an easier operation.

### BRIEF DESCRIPTION OF THE DRAWINGS

FIG. 1 is a schematic view of an external cutter structure of a preferred embodiment of the present invention;

FIG. 1-1 is a schematic view of a planar top side of a preferred embodiment of the present invention;

FIG. 1-2 is a schematic view of a curved top side of a preferred embodiment of the present invention;

FIG. 2 is a cross-sectional view of an external cutter structure in accordance with a first preferred embodiment of the present invention;

FIG. 3 is a cross-sectional view of an external cutter structure in accordance with a second preferred embodiment of the present invention;

FIG. 4 is a cross-sectional view of an external cutter structure in accordance with a third preferred embodiment of the present invention;

FIG. 5 is a schematic view of a planar top side in accordance with a fourth preferred embodiment of the present invention;

FIG. 5-1 is a schematic view of a curved top side in accordance with the fourth preferred embodiment of the present invention;

FIG. 6 is a cross-sectional view of the fourth preferred embodiment of the present invention;

FIG. 7 is a schematic view of a curved top side in accordance with a fifth preferred embodiment of the present invention;

FIG. 7-1 is a schematic view of a planar top side in accordance with the fifth preferred embodiment of the present invention;

FIG. 8 is a cross-sectional view of the fifth preferred embodiment of the present invention;

FIG. 9 is a schematic view of a structure applied to a shaver in accordance with a preferred embodiment of the present invention;

FIG. 10 is a schematic view of a structure applied to a shaver in accordance with the fourth preferred embodiment of the present invention;

FIG. 11 is a schematic view of a structure applied to the fifth preferred embodiment of the present invention;

FIG. 12 is a flow chart of a first manufacturing method of the present invention;

FIG. 13 is a flow chart of a second manufacturing method of the present invention;

FIG. 14 is a flow chart of a third manufacturing method of the present invention; and

FIG. 15 is a flow chart of a fourth manufacturing method of the present invention.

### DETAILED DESCRIPTION OF THE PREFERRED EMBODIMENTS

The technical characteristics of the present invention will become apparent with the detailed description of the preferred embodiments and the illustration of the related drawings.

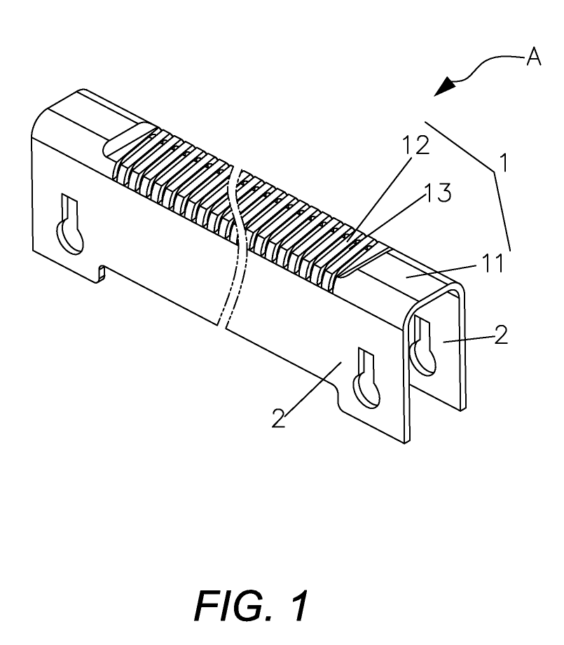

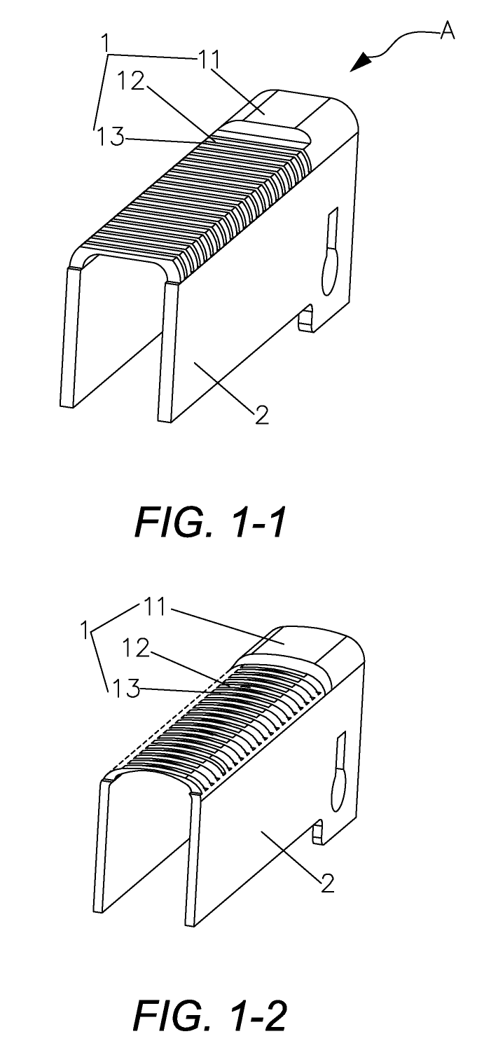

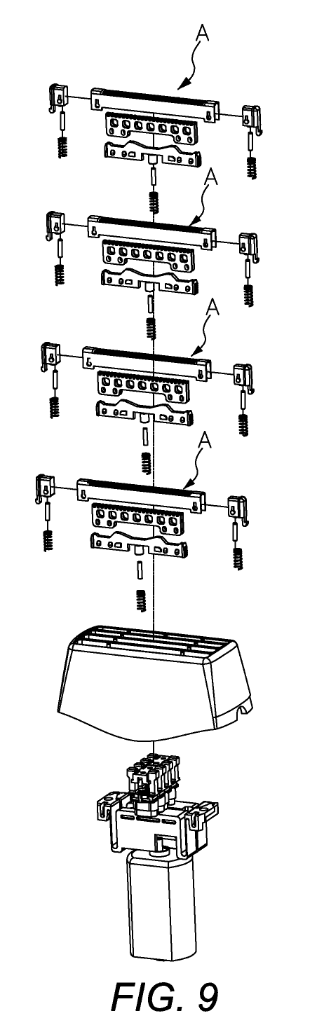

With reference to FIGS. 1, 3 to 5, and 7 for an external cutter structure of a reciprocating electric shaver in accordance with different preferred embodiment of the present invention, the external cutter A, B or C is formed by bending a thin plate into a strip shape, and the external cutter is transversally installed at a shaver head. With reference to FIGS. 9 to 11 as well, the thin plate in a strip shape includes a top side 1 and lateral sides 2, and the top side 1 includes a reinforcing portion 11 formed separately at both ends of the top side 1 and a blade portion 12 having a reduced thickness at the middle, and a plurality of long slots 13 are formed on the blade portion 12 of the top side 1 to manufacture a blade. The top side 1 has a planar surface as shown in FIGS. 1-1, 5, and 7-1 or a protruding curved surface as shown in FIGS. 1-2, 5-1, and 7.

In the present invention, the blade is formed by the long slots 13, and the blade portion 12 has an appropriate thickness, such that the manufactured shaver allows curly long beards to enter into the long slots 13 easily in order to shave both long beards or curly beards completely at a time, and the blade portion 12 is thin enough to shave the short beards, so as to achieve the effect of shaving both long beards or curly beards and short beards completely at a time. In addition, the transversally installed external cutter A, B or C increases the contact surface with a user's face to facilitate the shaving operation. More importantly, the external cutter of the present invention comes with a design of a thick reinforcing portion 11 formed separately at both ends and a thin blade at the middle, so as to avoid a decrease of the overall strength of the external cutter caused by the small thickness. Therefore, the external cutter structure of the present invention will not be deformed easily, even after a long time of use. The external cutter can be attached onto a user's face closer to assure the effect of shaving different kinds of beards completely and quickly.

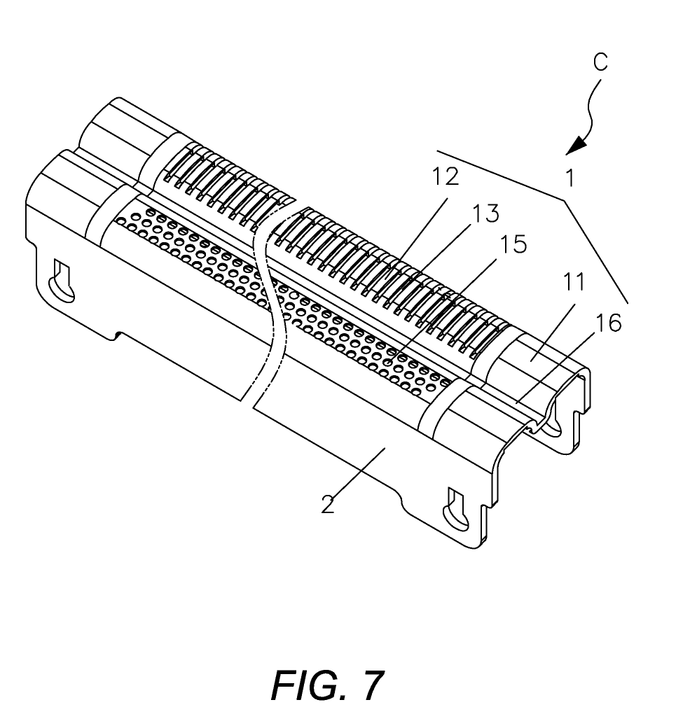

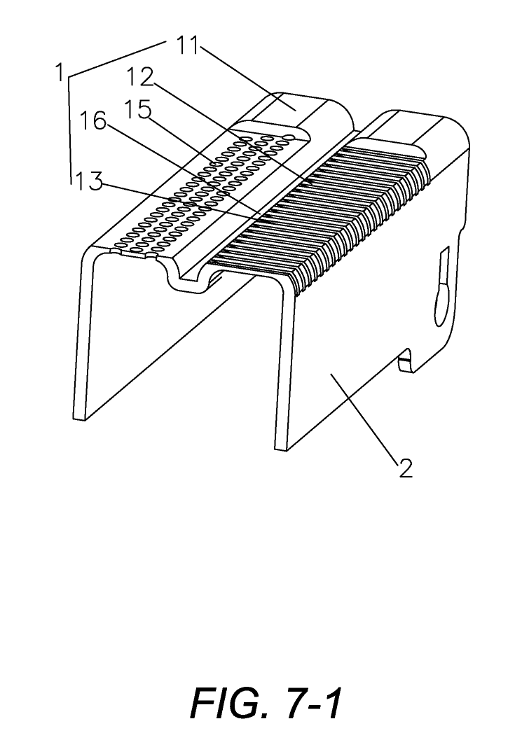

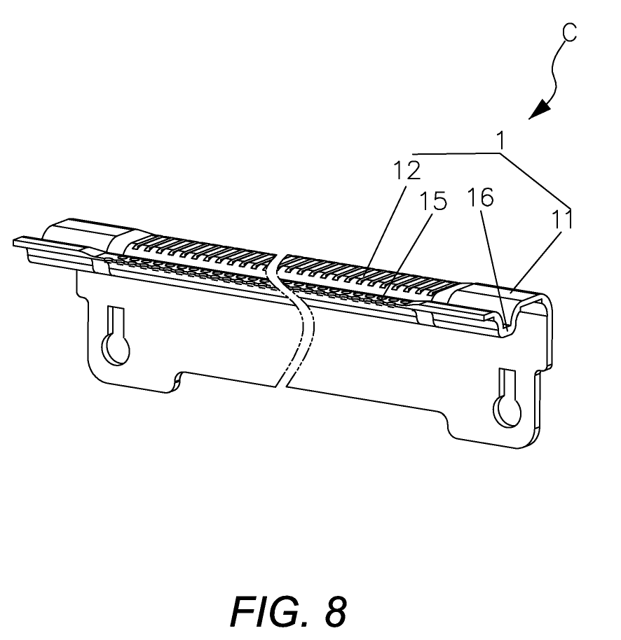

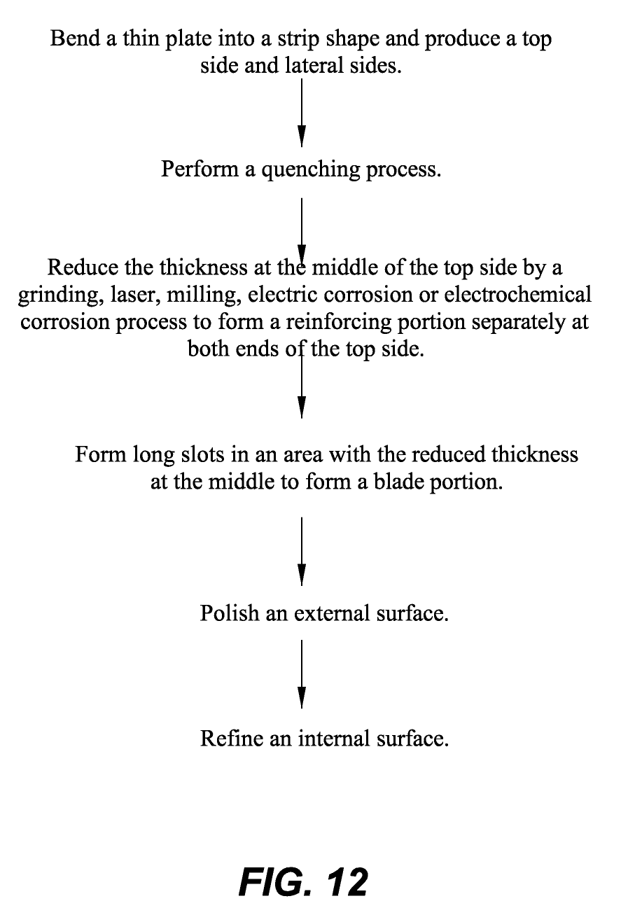

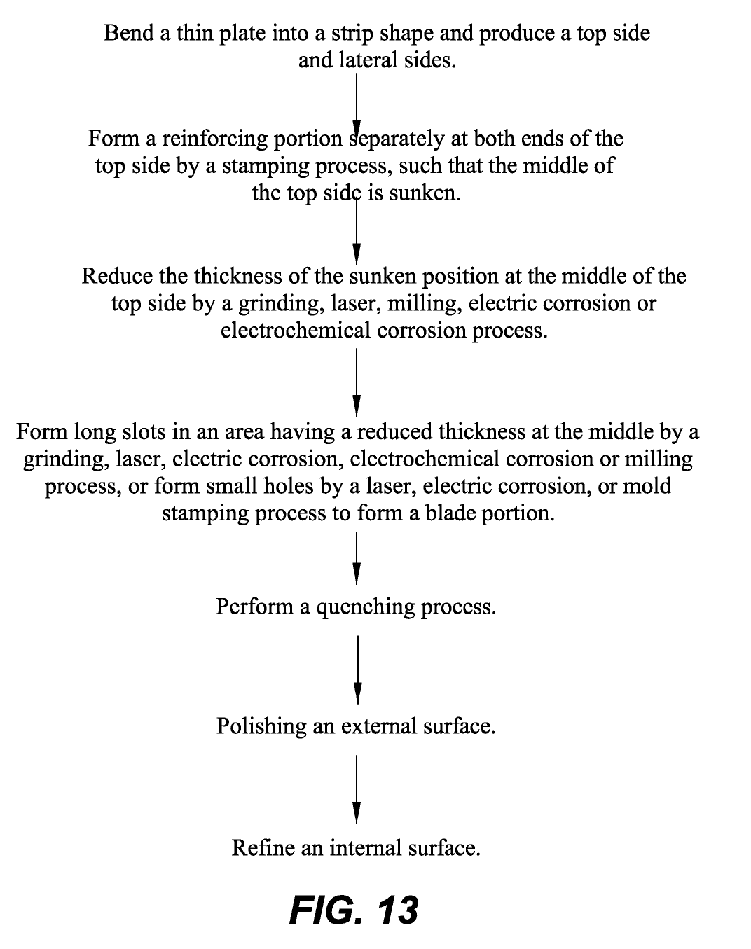

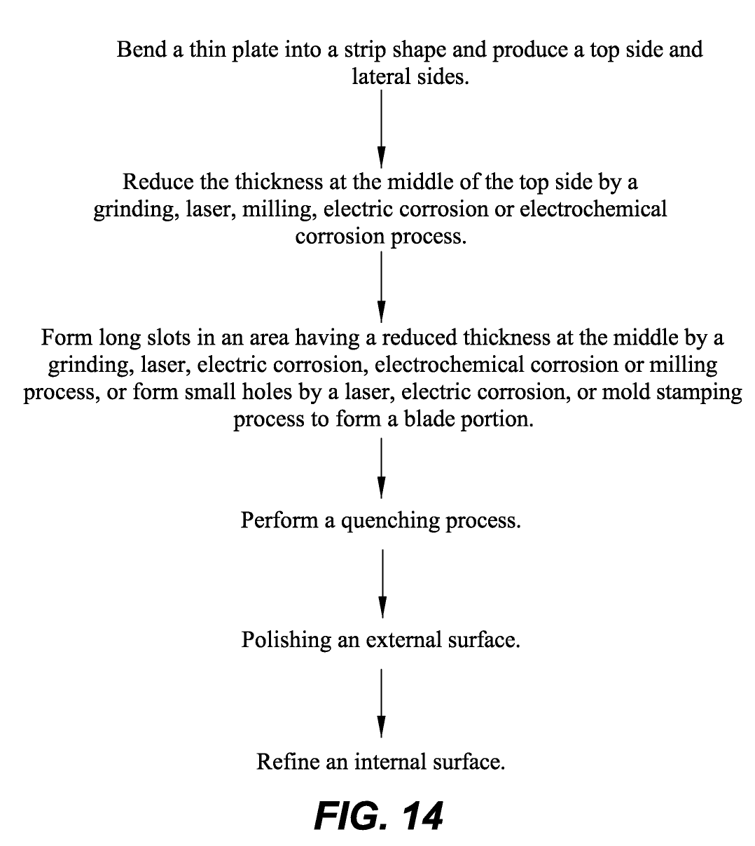

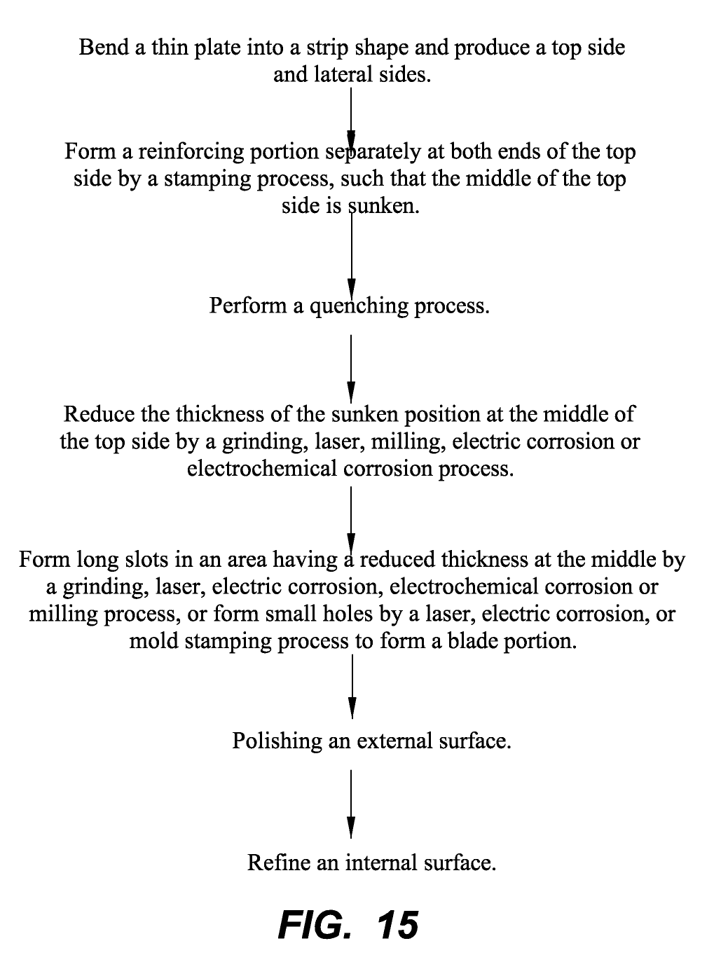

The present invention has the advantages of a simple structure and an easy manufacturing process. In FIG. 12, the manufacturing method of the present invention comprises the steps of: bending a thin plate into a strip shape; forming a top side 1 and lateral sides 2; performing a quenching process; reducing the thickness at the middle of the top side 1 of the strip shape by any one or a combination of grinding, laser, milling, electric corrosion and electrochemical corrosion methods; forming a reinforcing portion separately at both ends of the top side 1; forming long slots 13 in an area with a reduced thickness at the middle by any one or a combination of the grinding, laser, electric corrosion, electrochemical corrosion and milling methods to manufacture the blade portion 12, wherein the long slot 13 is extended from the top side 1 to a position of the lateral side 2 proximate to the top side 1 to allow long beards and curly beards to enter into the shaver. With reference to FIGS. 7 and 8 for a fifth preferred embodiment of the present invention, holes are punched in the area with the reduced thickness at the middle of the top side 1 of the external cutter by any one or a combination of laser boring, electric corrosion boring, and electrochemical corrosion boring method to produce small holes 15. Finally, an external surface is polished, and an internal surface is refined to produce a finished good of the external cutter. The manufacturing method of the external cutter in accordance with the present invention is illustrated by the flow chart as shown in FIG. 13, wherein a thin plate is stamped and bent into a strip shape, and a top side 1 and lateral sides 2 are formed, and a reinforcing portion 11 is stamped and formed separately at both ends of the top side 1, wherein the middle of the top side 1 is sunken, and the thickness at the sunken position at the middle of the top side 1 is reduced by any one or a combination of the grinding, laser, milling, electric corrosion and electrochemical corrosion methods, and then long slots 13 are formed in the area having the reduced thickness at the middle by any one of the grinding, laser, electric corrosion, electrochemical corrosion and milling methods to manufacture the blade portion 12. In the fifth preferred embodiment as shown in FIGS. 7 and 8, small holes 15 are formed in the area having the reduced thickness at the middle of the top side 1 of the external cutter by any one or a combination of mold stamping, laser, electric corrosion and electrochemical corrosion methods, and then a quenching process is performed, and finally an external surface is polished and an internal surface is refined to produce a finish good of the external cutter. Other manufacturing methods of the external cutter in accordance with the present invention are illustrated by the flow charts as shown in FIGS. 14 and 15 respectively, and FIG. 14 shows a manufacturing method similar to that as illustrated in FIG. 12, except the quenching process takes place before the steps of polishing the external surface and refining the and internal surface. In the fifth preferred embodiment as shown in FIGS. 7 and 8, small holes 15 are formed in an area with a reduced thickness at the middle of the top side 1 of the external cutter to enhance the mold stamping craftsmanship, wherein the small holes 15 are formed by any one or a combination of laser, electric corrosion, electrochemical corrosion and mold stamping methods. FIG. 15 is similar to FIG. 13, except the quenching process takes place after the reinforcing portions are stamped and formed at both ends of the top side respectively instead of before the external surface is polished and the internal surface is refined. In the fifth preferred embodiment as shown in FIGS. 7 and 8, the mold stamping process cannot be adopted for making the small holes 15 in the area having a reduced thickness at the middle of the top side 1 of the external cutter, and any one or a combination of laser, electric corrosion, and electrochemical corrosion method is used instead.

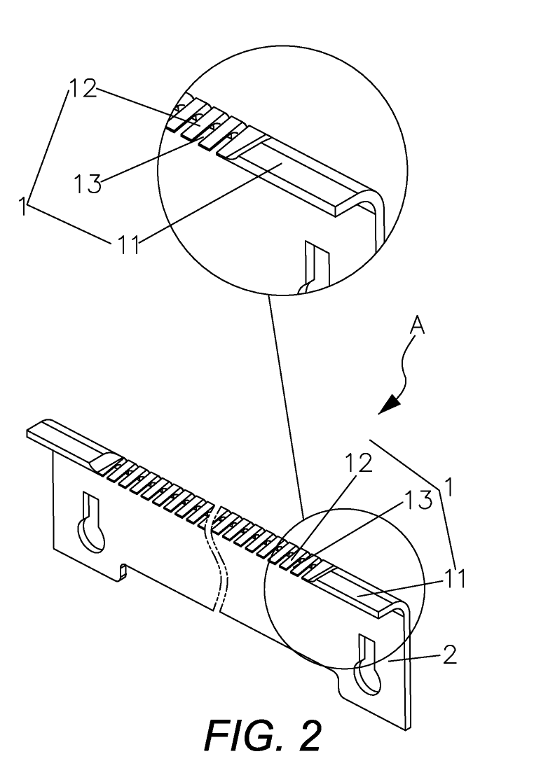

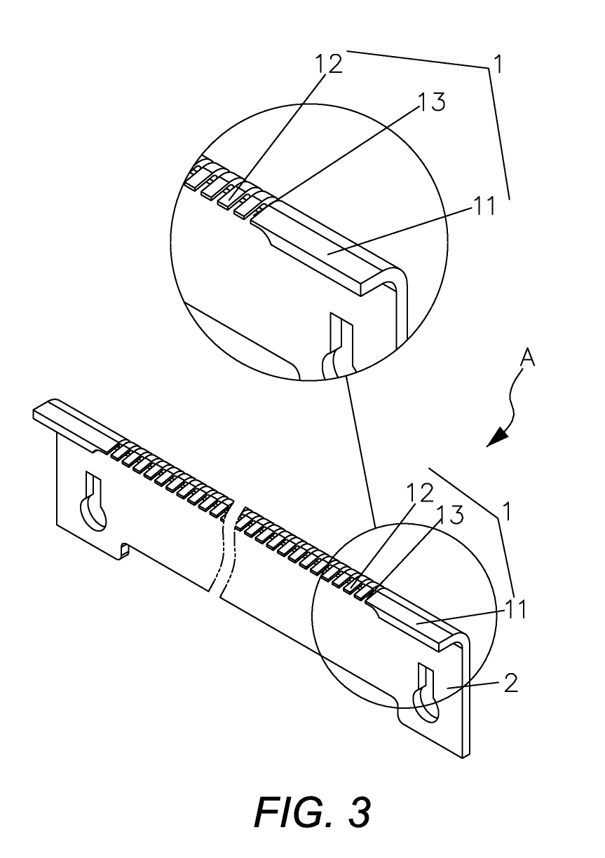

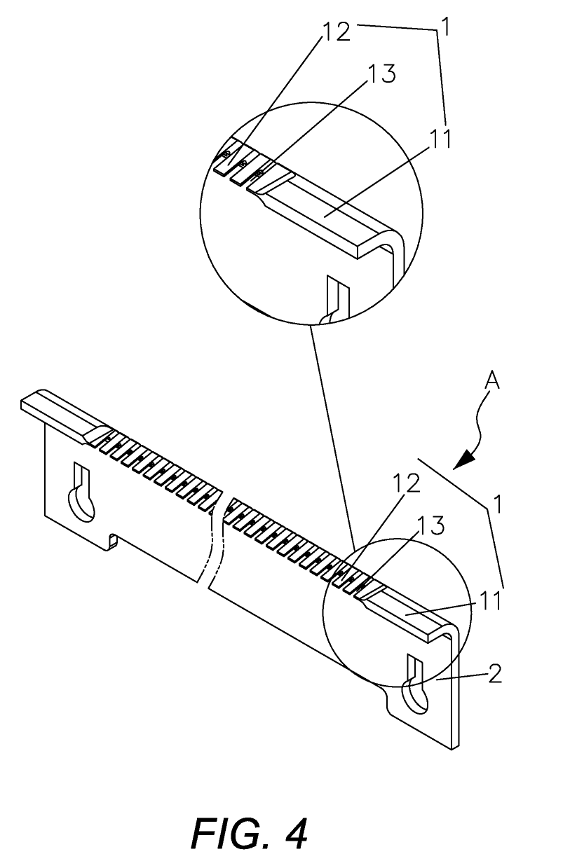

During the manufacturing process, an external cutter A as shown in FIGS. 1, 1-1 and 1-2 has a reduced thickness of an external surface at the middle of the top side 1, such that the reinforcing portions 11 at both ends of the external surface of the top side 1 are higher than the blade portion 12 to form a step shape, and the reinforcing portions 11 at both ends of the internal surface of the top side 1 are aligned evenly with the blade portion 12, or the thickness of the internal surface at the middle of the top side 1 is reduced as shown in FIG. 3, such that the reinforcing portions 11 at both ends of the external surface of the top side 1 are aligned evenly with the blade portion 12, and the reinforcing portions 11 at both ends of the internal surface of the top side 1 are lower than the blade portion 12 to form a step shape; or the thicknesses of both internal surface and external surface at the middle of the top side 1 are reduced as shown in FIG. 4, such that the reinforcing portions 11 at both ends of the external surface of the top side 1 are higher than the blade portion 12 to form a step shape, and the reinforcing portions 11 at both ends of the internal surface of the top side 1 are lower than the blade portion 12 to form the step shape as well. The three aforementioned manufacturing methods are applicable for manufacturing the external cutters B and C as shown in FIGS. 5, 5-1 and 8 and other types of external cutters which are not described here. The enhanced strength of the external cutter of the present invention facilitates the installation of the external cutter onto the shaver and provides an easier assembling operation.

In the present invention, the thickness of the reinforcing portions 11 at both ends of top side 1 is preferably equal to 0.1-0 6 mm for saving material, facilitating the manufacture, and assuring the strength of the external cutter, and the thickness of the blade portion 12 of the top side 1 is preferably equal to 0.04-0.09 mm for achieving the best shaving effect.

To extend beards into the long slots 13 easily and achieve the effect of shaving long beards and curly beards completely at a time, the present invention further extends the long slots 13 formed on the blade portion 12 from the top side 1 to positions of the lateral side 2 proximate to the top side 1 and designs the top side of the blade portion 12 with an arc shape for facilitating the blade portion 12 to be attached onto a user's face closely to provide a quicker and cleaner shaving effect.

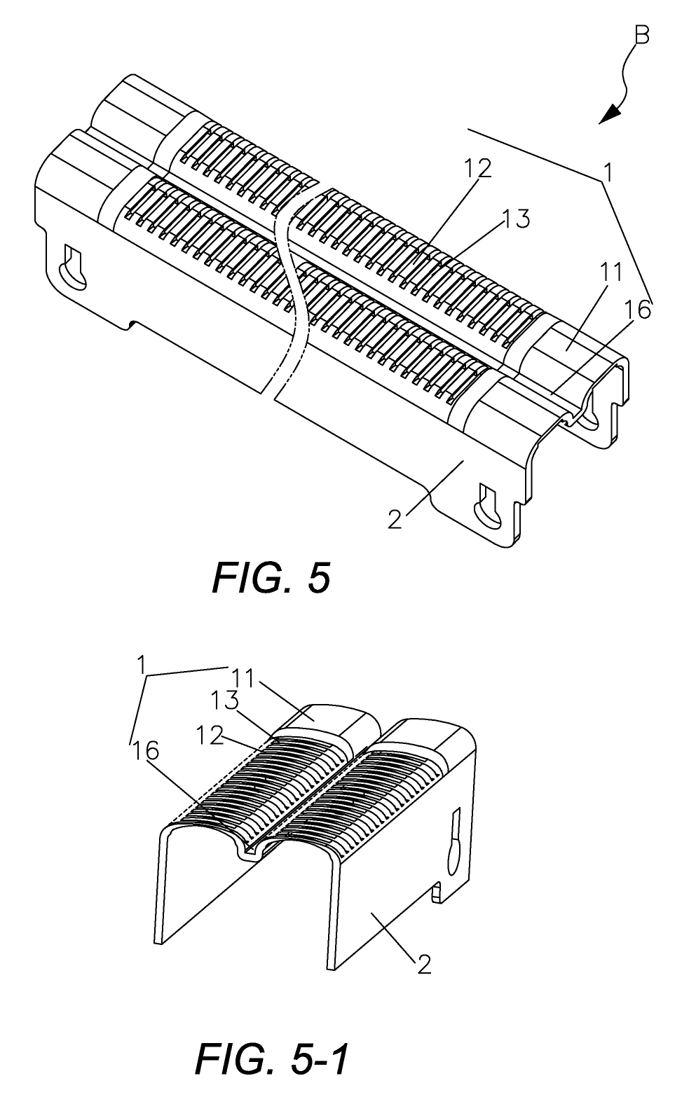

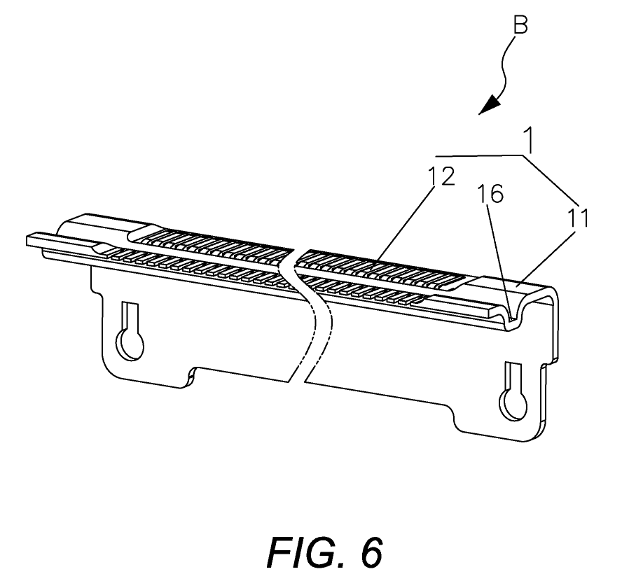

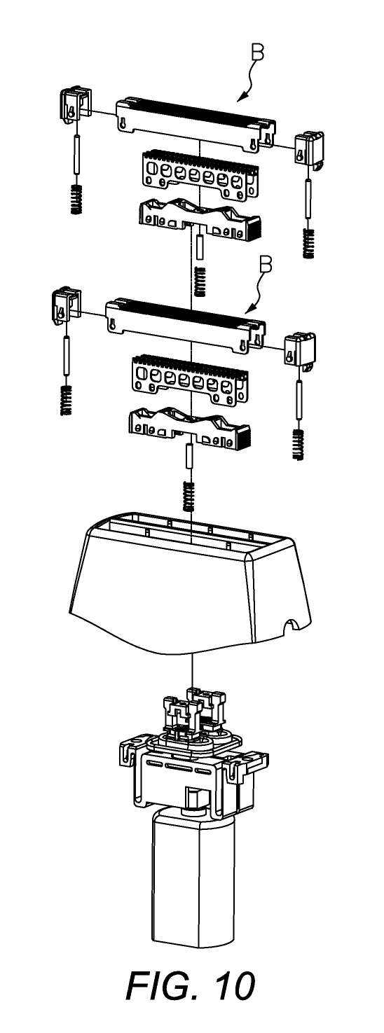

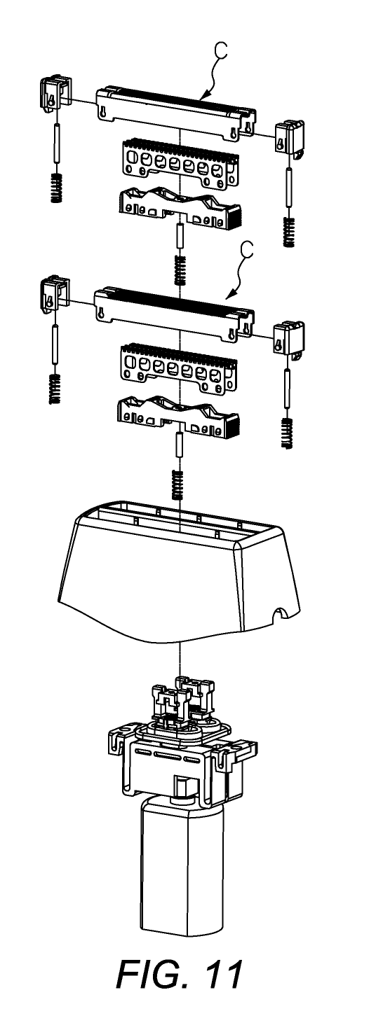

When the shaver of the present invention is used, the external cutters have four or more rows of long slots 13 (wherein four rows are shown in the figure) to manufacture the blade. In FIG. 9, each row of blades is formed independently, and the structure of each row of blades as shown in FIGS. 1, 2 and 3 is formed by bending a thin plate into an independent strip shape, and each independent strip shape has a top side 1 and lateral sides 2, and the top side 1 of each independent strip shape is divided into a reinforcing portion 11 formed separately at both ends of the top side 1 and a blade portion 12 with a reduced thickness at the middle. Long slots 13 are formed on the blade portion 12 of the top side 1 of each independent strip shape to form a row of blades, and the rows of blades are parallel to each other, and transversally installed at a shaver head. In FIG. 10, there are two or more rows of blades (wherein two rows are shown in the figure), and the blade can be integrally formed by bending a same piece of thin plate into a strip shape. With reference to FIG. 5 as well, the strip shape has a top side 1 and lateral sides 2, and the top side 1 is divided into a reinforcing portion 11 formed separately at both ends of the top side and a blade portion 12 with a reduced thickness at the middle, wherein the long slots 13 are formed on the blade portion 12 of the top side 1 of the strip shape to form two or more rows of parallel blades, and the area of blades on the same strip shape is increased to assure the overall strength of the external cutters. In addition, a reinforcing rib 16 can be stamped and formed between two adjacent rows of blades on the same strip structure. To improve the shaving efficiency, the external cutters of the present invention adopt long-slot blades and small-hole blades arranged alternately with each other, and the two types of blades can achieve a better effect of shaving both long beards and short beards completely at the same time, and the two types of blades can be formed separately as shown in FIG. 9. In other words, each blade is formed by bending a thin plate into an independent strip shape, and each independent strip shape has a top side and lateral sides, and the top side of each independent strip shape is divided into a reinforcing portion formed separately at both ends of the top side and a blade portion with a reduced thickness at the middle, and long slots are formed on the blade portion of the top side of each independent strip shape to form a row of blades and, and the rows of blades are parallel to each other and transversally installed at a shaver head. The two types of blades can be integrally formed on the same piece of thin plate bent into the strip shape as shown in FIG. 11 (which is similar to FIG. 10). With reference to FIG. 7 as well, the strip shape has a top side 1 and lateral sides 2, and the top side 1 is divided into a reinforcing portion 11 formed separately at both ends of the top side 1 and a blade portion 12 having a reduced thickness at the middle, and long slots 13 and small holes 15 are formed on the blade portion 12 of the top side 1 to form a row of blades, and the long-slot blades and small-hole blades are parallel to each other, and a reinforcing rib 16 is also stamped and formed between two adjacent rows of blades for enhancing the strength of the external cutter. Of course, the present invention can be implemented by other embodiments.

The present invention is characterized in that the thickness at the middle of the top side 1 of the external cutter is reduced to form the blade portion 12, and the long slots 13 are formed on the blade portion 12 to form the blade, and the blade has an appropriate thickness, wherein the long slots 13 provide a convenient way of extending long beards and curly beards into the shaver and shaving the long beards or curly beards completely at a time. The blade is thin enough to shave the short beards completely at the same time, so as to achieve the effect of shaving long beards or curly beards and short beards completely at a time, and the thickness at both ends of the top side 1 is not reduced, such that the original thickness can be maintained to form the reinforcing portion 11, so as to achieve the effects of enhancing the strength of the external cutter, preventing the external cutter from being deformed easily, and extending the lifespan of the external cutter.

The present invention improves over the prior art and complies with patent application requirements, and thus is duly filed for the patent application.

While the invention has been described by device of specific embodiments, numerous modifications and variations could be made thereto by those generally skilled in the art without departing from the scope and spirit of the invention set forth in the claims.

What is claimed is:

1. An external cutter structure of a reciprocating electric shaver, comprising an external cutter formed by bending a thin plate into a substantially strip shape and transversally installed at a shaver head, and the external cutter structure having a top side and lateral sides, and the top side including a reinforcing portion disposed separately at both ends of the top side, a blade portion having a reduced thickness at the middle of the blade portion, and a plurality of long slots formed on the blade portion of the top side to form a blade.

2. The external cutter structure of a reciprocating electric shaver as recited in claim 1, wherein the external surface at the middle of the top side has a reduced thickness, and the reinforcing portions at both ends of the external surface of the top side are higher than the blade portion to form a substantially step shape, and the reinforcing portions at both ends of the internal surface the top side are aligned evenly with the blade portion.

3. The external cutter structure of a reciprocating electric shaver as recited in claim 1, wherein the thickness of the internal surface at the middle of the top side is reduced, and the reinforcing portions formed separately at both ends of the external surface of the top side are aligned evenly with the blade portion, and the reinforcing portions formed separately at both ends of the internal surface of the top side are lower than the blade portion to form a step shape.

4. The external cutter structure of a reciprocating electric shaver as recited in claim 1, wherein the thicknesses of both internal surface and external surface at the middle of the top side are reduced, and the reinforcing portions formed separately at both ends of the external surface of the top side are higher than the blade portion to form a step shape, and the reinforcing portions formed separately at both ends of the internal surface of the top side are lower than the blade portion to form a step shape.

5. The external cutter structure of a reciprocating electric shaver as recited in claim 1, wherein the long slot formed on the blade portion is extended from the top side to a position of the lateral side proximate to the top side.

6. The external cutter structure of a reciprocating electric shaver as recited in claim 1, wherein the top side of the blade portion is substantially a plane.

7. The external cutter structure of a reciprocating electric shaver as recited in claim 1, wherein the top side of the blade portion is substantially a protruding curved surface.

8. The external cutter structure of a reciprocating electric shaver as recited in claim 1, wherein each reinforcing portion formed separately at both ends of the top side has a thickness equal to 0.1-0.6 mm

9. The external cutter structure of a reciprocating electric shaver as recited in claim 1, wherein the blade portion of the top side has a thickness equal to 0.04-0.09 mm

10. The external cutter structure of a reciprocating electric shaver as recited in claim 1, wherein the external cutter of the shaver has two or more rows of bladed formed by the long slots, and the rows of blades are formed independently by bending a thin plate into an independent strip shape, and each independent strip shape has a top side and lateral sides, and the top side of each independent strip shape includes a reinforcing portion formed separately at both ends of the top side and a blade portion having a reduced thickness at the middle, and long slots are formed on the blade portion of the top side of each independent strip shape to form a row of blades, and the rows of blades are parallel to each other and transversally installed at the shaver head.

11. The external cutter structure of a reciprocating electric shaver as recited in claim 1, wherein the external cutter of the shaver includes two or more rows of blades formed by the long slots, and the two or more rows of blades are integrally formed by bending a same piece of thin plate into a strip shape, and the strip shape has a top side and lateral sides, and the top side includes a reinforcing portion formed separately at both ends of the top side and a blade portion having a reduced thickness at the middle, and long slots are formed on the blade portion of the top side of the strip shape to form two or more rows of parallel blades.

12. The external cutter structure of a reciprocating electric shaver as recited in claim 11, further comprising a reinforcing rib formed between two rows of blades by stamping.

13. The external cutter structure of a reciprocating electric shaver as recited in claim 1, wherein the external cutter of the shaver comprises long-slot blades and small-hole blades alternately arranged with each other, and the two types of blades are formed separately by bending a thin plate into an independent strip shape, each independent strip shape has a top side and lateral sides, and the top side of each independent strip shape includes a reinforcing portion formed separately at both ends of the top side and a blade portion having a reduced thickness at the middle, and long slots and small holes are formed on the blade portion on the top side of each independent strip shape to form a row of blades, and the rows of blades are parallel to each other and transversally installed at a shaver head.

14. The external cutter structure of a reciprocating electric shaver as recited in claim 1, wherein the external cutter of the shaver comprises long-slot blades and small-hole blades alternately arranged with each other, and the two types of blades are formed by bending a same piece of thin plate into a strip shape, and the strip shape has a top side and lateral sides, and the top side of the strip shape includes a reinforcing portion formed separately at both ends of the top side and a blade portion having a reduced thickness at the middle, and long slots and small holes are formed at the blade portion on the top side of the strip shape to form a row of blades, and long-slot blades and small-hole blades are parallel to each other.

15. The external cutter structure of a reciprocating electric shaver as recited in claim 14, further comprising a reinforcing rib formed between two rows of blades by stamping.

16. A manufacturing method of an external cutter shaver of a reciprocating electric shaver, comprising the steps of:
bending a thin plate into a strip shape;
forming a top side and lateral sides,
performing a quenching process;
reducing the thickness at the middle of the top side of the strip shaped external cutter,
forming a reinforcing portion separately at both ends of the top side;
forming long slots in an area having a reduced thickness at the middle to form a blade portion; and
polishing an external surface and refining an internal surface.

17. The manufacturing method of an external cutter shaver of a reciprocating electric shaver as recited in claim 16, wherein the thickness at the middle of the top side of the external cutter is reduced by any one or a combination of grinding, laser, milling, electric corrosion and electrochemical corrosion processes.

18. The manufacturing method of an external cutter shaver of a reciprocating electric shaver as recited in claim 16, wherein the thickness at the middle of the top side of the external cutter is reduced by any one or a combination of grinding, laser, milling, electric corrosion and electrochemical corrosion processes to manufacture the long slots.

19. The manufacturing method of an external cutter shaver of a reciprocating electric shaver as recited in claim 16, wherein the thickness at the middle of the top side of the external cutter is reduced by any one or a combination of laser, electric corrosion, and electrochemical corrosion processes to manufacture the small holes.

20. A manufacturing method of an external cutter shaver of a reciprocating electric shaver, comprising the steps of:
bending a thin plate into a strip shape;
forming a top side and lateral sides,
performing a quenching process;
reducing the thickness at the middle of the top side of the strip shaped external cutter;
forming a reinforcing portion separately at both ends of the top side;
forming long slots in an area having a reduced thickness at the middle to form a blade portion;
performing a quenching process; and
polishing an external surface and refining an internal surface.

21. The manufacturing method of an external cutter shaver of a reciprocating electric shaver as recited in claim 20, wherein the thickness at the middle of the top side of the external cutter is reduced by any one or a combination of grinding, laser, milling, electric corrosion and electrochemical corrosion processes.

22. The manufacturing method of an external cutter shaver of a reciprocating electric shaver as recited in claim 20, wherein the thickness at the middle of the top side of the external cutter is reduced by any one or a combination of grinding, laser, milling, electric corrosion and electrochemical corrosion processes to manufacture the long slots.

23. The manufacturing method of an external cutter shaver of a reciprocating electric shaver as recited in claim 20, wherein the thickness at the middle of the top side of the external cutter is reduced by any one or a combination of laser, electric corrosion, and electrochemical corrosion processes to manufacture the small holes.

24. A manufacturing method of an external cutter shaver of a reciprocating electric shaver, comprising the steps of:
bending a thin plate into a strip shape;
forming a top side and lateral sides,
forming a reinforcing portion separately at both ends of the top side by a stamping process, wherein the middle of the top side is sunken;
reducing the thickness at the sunken position at the middle of the top side;
forming long slots in an area having a reduced thickness at the middle to form a blade portion;
performing a quenching process; and
polishing an external surface and refining an internal surface.

25. The manufacturing method of an external cutter shaver of a reciprocating electric shaver as recited in claim 24, wherein the thickness at the middle of the top side of the external cutter is reduced by any one or a combination of grinding, laser, milling, electric corrosion and electrochemical corrosion processes.

26. The manufacturing method of an external cutter shaver of a reciprocating electric shaver as recited in claim 24, wherein the thickness at the middle of the top side of the external cutter is reduced by any one or a combination of laser, electric corrosion, and electrochemical corrosion processes to manufacture the long slots.

27. The manufacturing method of an external cutter shaver of a reciprocating electric shaver as recited in claim 24, wherein the thickness at the middle of the top side of the external cutter is reduced by any one or a combination of mold stamping, laser, electric corrosion, and electrochemical corrosion processes to manufacture the small holes.

28. A manufacturing method of an external cutter shaver of a reciprocating electric shaver, comprising the steps of:
bending a thin plate into a strip shape;
forming a top side and lateral sides,
forming a reinforcing portion separately at both ends of the top side by a stamping process, wherein the middle of the top side is sunken;
performing a quenching process;
reducing the thickness at the sunken position at the middle of the top side;
forming long slots in an area having a reduced thickness at the middle to form a blade portion; and
polishing an external surface and refining an internal surface.

29. The manufacturing method of an external cutter shaver of a reciprocating electric shaver as recited in claim 28, wherein the thickness at the middle of the top side of the external cutter is reduced by any one or a combination of grinding, laser, milling, electric corrosion and electrochemical corrosion processes.

30. The manufacturing method of an external cutter shaver of a reciprocating electric shaver as recited in claim 28, wherein the thickness at the middle of the top side of the external cutter is reduced by any one or a combination of laser, electric corrosion, and electrochemical corrosion processes to manufacture the long slots.

31. The manufacturing method of an external cutter shaver of a reciprocating electric shaver as recited in claim 28, wherein the thickness at the middle of the top side of the external cutter is reduced by any one or a combination of laser, electric corrosion, and electrochemical corrosion processes to manufacture the small holes.
